(19) United States
(12) Patent Application Publication
(10) Pub. No.: US 2011/0226404 A1
(43) Pub. Date: Sep. 22, 2011

(54) Method and Apparatus for Toilet Seat Resurfacing

(76) Inventors: Timothy M. Sullivan, Corona, CA (US); Thomas Reilly, La Habra, CA (US)

(21) Appl. No.: 13/044,091

(22) Filed: Mar. 9, 2011

Related U.S. Application Data
(60) Provisional application No. 61/314,512, filed on Mar. 16, 2010.

(51) Int. Cl. B29C 73/26

(52) U.S. Cl. 156/98

(57) ABSTRACT

A method and apparatus for resurfacing a vandalized or damaged toilet seat, in commercial areas in particular. Overlays covering one half of the vandalized toilet seat are provided. Each overlay includes a self adhesive and a peel off cover. The overlays are preferably a thin vinyl material but may be any comparable material. The seat is sanded and cleaned, alignment marks may be made on the vandalized toilet seat and on the overlay, the peel off cover is removed to expose the adhesive, the alignment marks are aligned, the overlay is applied to the seat, and a squeegee used to smooth the overlay and remove bubbles. In another embodiment a plastic overlay snaps onto a damaged toilet seat covering about half the seat. Two overlays are generally applied in a first application to obtain a uniform appearance, and later a single overlay may be applied as needed.

The present application claims the priority of U.S. Provisional Patent Application Ser. No. 61/314,512 filed Mar. 16, 2010, which application is incorporated in its entirety herein by reference.

### BACKGROUND OF THE INVENTION

The present invention relates to repair of commercial toilet seats and in particular to resurfacing commercial toilet seats.

Commercial restrooms are often the victim of vandalism. For example, restaurant, fast food, and various retail establishments provide restrooms for their customers. Such restrooms are often small and limited to a single user, or a very small number of users, and often are occupied by a single individual. Further, due to the nature of restroom use, surveillance cameras are obviously not allowed. As a result, a single individual is often unobserved in commercial restrooms, and such conditions invite vandalism. One common form of restroom vandalism is marking for cutting gang graffiti into toilet seats.

Further, in addition to creating an unattractive appearance and drawing gang activities to the retail establishment, scratches in toilet seats create breeding environments for bacteria.

### BRIEF SUMMARY OF THE INVENTION

The present invention addresses the above and other needs by providing a method and apparatus for resurfacing a vandalized or damaged toilet seat, in commercial areas in particular. Overlays covering one half of the vandalized toilet seat are provided. Each overlay includes a self adhesive and a peel off cover. The overlays are preferably a thin vinyl material but may be any comparable material. The seat is sanded and cleaned, alignment marks may be made on the vandalized toilet seat and on the overlay, the peel off cover is removed to expose the adhesive, the alignment marks are aligned, the overlay is applied to the seat, and a squeegee used to smooth the overlay and remove bubbles. In another embodiment a plastic overlay snaps onto a damaged toilet seat covering about half the seat. Two overlays are generally applied in a first application to obtain a uniform appearance, and later a single overlay may be applied as needed.

In accordance with one aspect of the invention, there is provided a method for repairing a vandalized toilet seat. The method includes sanding half of a top surface of the vandalized toilet seat; cleaning the sanded top surface of the vandalized toilet seat; positioning an overlay over the sanded and cleaned half of the top surface of the vandalized toilet seat; applying overlapping alignment marks to the aligned overlay and the top surface of the vandalized toilet seat; removing a covering to expose adhesive on a bottom surface of the overlay; and using the overlapping alignment marks, positioning the overlay on the toilet seat. The overlay may be squeegeed after positioning to remove bubbles.

In accordance with another aspect of the invention, there is provided a method for initial repair and maintenance of a toilet seat. For an initial repair, separate overlays are applied to each side of the toilet seat to provide a uniform appearance. The toilet seat is maintained by applying a single overlay to a later damaged toilet seat half.

In accordance with yet another aspect of the invention, there is provided a method for initial repair and maintenance of a toilet seat. For an initial repair, snap on overlays are attached to each side of the toilet seat to provide a uniform appearance. The toilet seat is maintained by removing and replacing damaged snap on overlays.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a vandalized toilet seat.

FIG. 2 is the vandalized toilet seat after sanding through scratches according to the present invention.

FIG. 3 is the vandalized toilet seat after cleaning the sanded area according to the present invention.

FIG. 4 shows an overlay according to the present invention and the toilet seat marked for alignment.

FIG. 5 shows the overlay partially applied to the toilet seat according to the present invention.

FIG. 6 shows the repaired toilet seat with the overlay attached.

FIG. 7A shows a top view of a snap on overlay according to the present invention.

FIG. 7B shows a side view of the snap on overlay according to the present invention.

FIG. 8 is a cross-sectional view of the snap on overlay according to the present invention taken along line 8-8 of FIG. 7A.

FIG. 9 is the vandalized toilet seat before snapping the snap on overlay according to the present invention onto the toilet seat.

FIG. 10 shows the repaired toilet seat with the snap on overlay attached.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

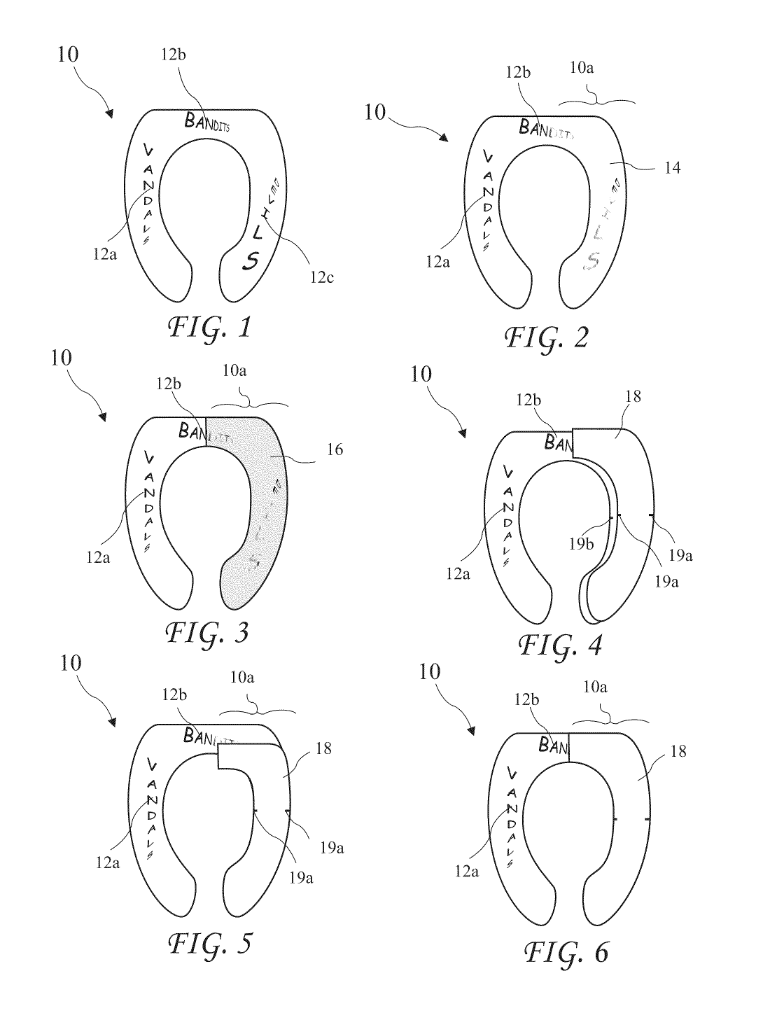

A vandalized toilet seat 10 is shown in FIG. 1. Toilet seats 10 are commonly vandalized in commercial areas requiring seat replacement. Such vandalizing may include both marks on a seat surface and scratches into the seat surface.

The vandalized toilet seat 10 after sanding through marks and/or scratches on one side of the toilet seat 10 according to the present invention is shown in FIG. 2. While the seat might be repaired without removing scratches, the presence of the scratches provides a breeding area for bacteria.

The vandalized toilet seat 10 after cleaning the sanded area according to the present invention is shown in FIG. 3. Any residue from sanding is preferably removed during cleaning to provide a surface for adhesive attachment of an overlay 18 according to the present invention.

The overlay 16 according to the present invention receives marks 19a and the toilet seat 10 receives marks 19b (only one of two marks 19b shown) as shown in FIG. 4. The marks 19a and 19b are for later alignment of the overlay 16 with the toilet seat 10 after a cover is removed from adhesive on a bottom surface of the overlay 16. The overlay 16 is preferably sized to cover a right or left side of the toilet seat 10 and is preferably a white plastic material and more preferably 3M Controltac™ film made my 3M in St. Paul Minn., and approximately 4 mil thick 3M Controltac™ film.

The overlay 16 is shown in FIG. 5 partially applied to the toilet seat 20 after removing the cover material from the adhesive side of the overlay 16. The marks 19a and 19b facilitate aligning the overlay 16 with the toilet seat. After applying the overlay 16, the overlay 16 may be squeegeed to remove bubbles between the overlay 16 and the top surface of the toilet seat 10.

The repaired toilet seat 10 with the overlay 16 attached is shown in FIG. 6. For an initial repair, overlays 16 are applied to both sides of the toilet seat 10 to provide a uniform appearance. The toilet seat 10 is maintained by applying a single overlay 16 to a later damaged toilet seat half. Previously applied overlays 16 may be removed to prevent a build up. Following applying the overlays 16, the toilet seat is cleaned to remove the alignment marks 19a from the overlay 16.

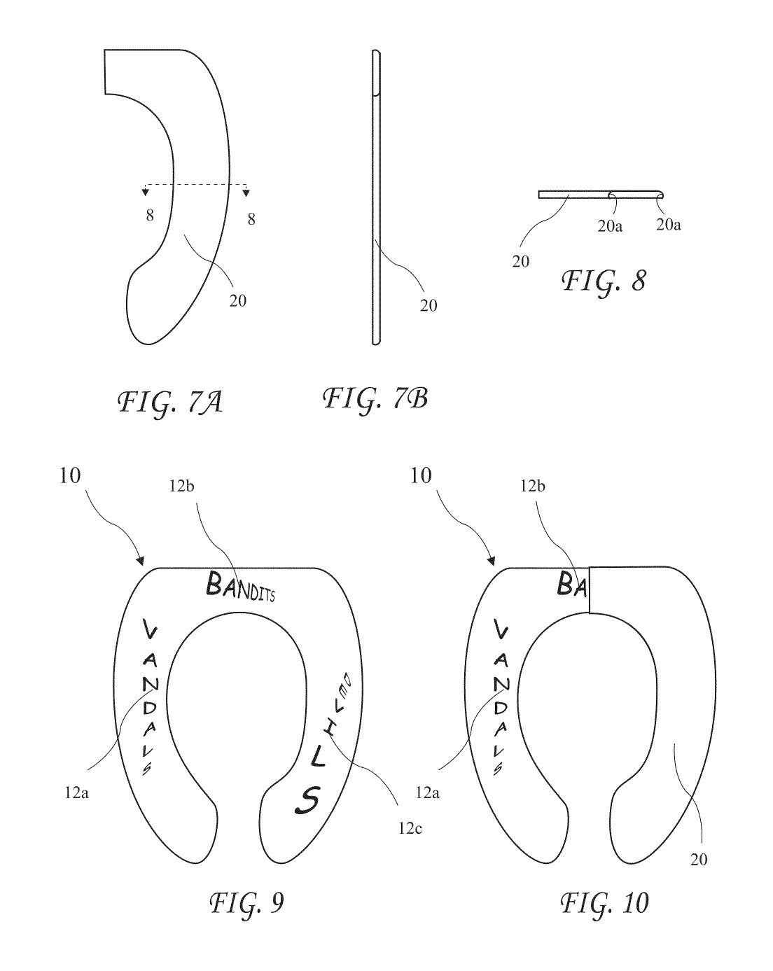

A top view of a snap on overlay 20 according to the present invention is shown in FIG. 7A, a side view of the snap on overlay 20 is shown in FIG. 7B, and a cross-sectional view of the snap on overlay 20 taken along line 8-8 of FIG. 7A is shown in FIG. 8. The snap on overlay 20 is shaped with a curled edge 20a to reach around the edges of the toilet seat 10 to hold the snap on overlay 20 on the toilet seat 10. The snap on overlay 20 may be cut to fit around hinges as needed.

The vandalized toilet seat 10 is shown in FIG. 9 before snapping the snap on overlay 20 onto the toilet seat 10 and the repaired toilet seat 10 with the snap on overlay attached is shown in FIG. 10. When both sides of a seat 10 have been vandalized, both right and left snap on overlays 20 may be used to repair the seat 10, or a single full size overlay may be used to repair the seat 10.

While the invention herein disclosed has been described by means of specific embodiments and applications thereof, numerous modifications and variations could be made thereto by those skilled in the art without departing from the scope of the invention set forth in the claims.

I claim:

1. A method for repairing a vandalized toilet seat, the method comprising:
sanding half of a top surface of the toilet seat;
cleaning the sanded top surface of the toilet seat;
removing a covering to expose adhesive on a bottom surface of an overlay; and
positioning the overlay on the toilet seat.

2. The method of claim 1, wherein the overlay configured to approximately cover one of a right and left half of the top surface of the toilet seat.

3. The method of claim 2, further including the steps of:
before exposing the adhesive on the bottom surface of the overlay, positioning the overlay over the sanded and cleaned half of the top surface of the toilet seat;
applying overlapping alignment marks to the aligned overlay and the top surface of the toilet seat; and
after exposing the adhesive on the bottom surface of the overlay, using the overlapping alignment marks to position the overlay on the toilet seat.

4. The method of claim 1, further including applying a second overlay to an uncovered half of the top surface of the toilet seat.

5. The method of claim 4, further including applying a second overlay to an uncovered half of the top surface of the toilet seat.

6. The method of claim 5, further including later applying an overlay to a subsequently damaged half of the top surface of the toilet seat.

7. The method of claim 6, further including removing a damaged overlay before later applying an overlay to a subsequently damaged half of the top surface of the toilet seat

8. The method of claim 1, wherein the overlay is a white plastic material.

9. The method of claim 8, wherein the overlay is an approximately four mils thick white plastic material.

10. A method for repairing a vandalized toilet seat, the method comprising:
sanding half of a top surface of the toilet seat;
cleaning the sanded top surface of the toilet seat;
positioning an overlay configured to approximately cover a first half of the top surface of the toilet seat, over the sanded and cleaned first half of the top surface of the toilet seat;
applying overlapping alignment marks to the aligned overlay and the top surface of the toilet seat; and
removing a covering to expose adhesive on a bottom surface of the overlay;
using the overlapping alignment marks to position the overlay on the first half of the toilet seat;
applying the overlay to the first half of the toilet seat;
removing a covering to expose adhesive on a second bottom surface of a second overlay configured to approximately cover a second half of the top surface of the toilet seat adjacent to the first half of the top surface of the toilet seat;
positioning the second overlay on the second half of the top surface of the toilet seat; and
applying the second overlay to the second half of the top surface of the toilet seat.

11. A method for repairing a vandalized toilet seat, the method comprising:
sanding half of a top surface of the toilet seat;
cleaning the sanded top surface of the toilet seat;
positioning an overlay made of a white plastic material and configured to approximately cover a first half of the top surface of the toilet seat, over the sanded and cleaned first half of the top surface of the toilet seat;
applying overlapping alignment marks to the aligned overlay and the top surface of the toilet seat; and
removing a covering to expose adhesive on a bottom surface of the overlay;
using the overlapping alignment marks to position the overlay on the first half of the toilet seat;
applying the overlay to the first half of the toilet seat;
squeegeeing the overlay to remove bubbles;
removing a covering to expose adhesive on a second bottom surface of a second overlay made of the white plastic material and configured to approximately cover a second half of the top surface of the toilet seat adjacent to the first half of the top surface of the toilet seat;
positioning the second overlay on the second half of the top surface of the applying the second overlay to the second half of the top surface of the toilet seat;
squeegeeing the second overlay to remove bubbles; and
repairing later damaged overlays by applying a third overlay configured to cover the half of the toilet seat covered by the damaged overlay.
